(19) United States
(12) Patent Application Publication
(10) Pub. No.: US 2012/0288306 A1
(43) Pub. Date: Nov. 15, 2012

(54) CONDUCTIVE MEMBER FOR ELECTROPHOTOGRAPHIC DEVICE

(75) Inventors: Keiichi Ikegami, Nishikasugai-gun (JP); Kadai Takeyama, Komaki-shi (JP)

(73) Assignee: TOKAI RUBBER INDUSTRIES, LTD., Komaki-shi (JP)

(21) Appl. No.: 13/561,767

(22) Filed: Jul. 30, 2012

Related U.S. Application Data
(63) Continuation of application No. PCT/JP2011/068538, filed on Aug. 16, 2011.

(30) Foreign Application Priority Data
Aug. 25, 2010 (JP) 2010-188141

(51) Int. Cl. G03G 15/00

(52) U.S. Cl. 399/130

(57) ABSTRACT

A conductive member for an electrophotographic device includes a conductive rubber elastic layer. The conductive rubber elastic layer is composed of a cross-linked product of a conductive rubber composition containing (a) a polar rubber, (b) at least one ion-conductive agent selected from diallyldimethylammonium.bis(trifluoromethanesulfonyl)imide and diallyldimethylammonium.trifluoromethanesulfonate and (c) a cross-linking agent, and the cross-linked product has a relative dielectric constant of 23 or more.

### BACKGROUND OF THE INVENTION

1. Field of the Invention

The present invention relates to a conductive member for an electrophotographic device, such as a developing roller or a charging roller, used in an electrophotographic device such as a copy machine, a printer, or a facsimile machine.

2. Description of the Related Art

Electrophotographic devices that use an electrophotographic system, such as a copy machine, a printer or a facsimile machine, are known. In general, such an electrophotographic device includes a photoconductor drum inside thereof, and conductive members such as conductive rollers, e.g., a developing roller, a charging roller, a transfer roller and a toner supply roller, and conductive belts, e.g., a transfer belt is arranged around the photoconductor drum.

For example, the conductive roller has a two-layer structure in which a base layer composed of a rubber elastomer is provided on the outer periphery of a metal core and a surface layer that protects the base layer is provided on the surface of the base layer, or a three-layer structure in which a layer that is composed of a rubber elastomer and that functions as, for example, a resistance-adjusting layer for adjusting the resistance of the conductive roller is provided between the base layer and the surface layer. For example, the conductive belt has a two-layer structure including a base layer composed of a rubber elastomer and a surface layer that protects the base layer and that is provided on the surface of the base layer.

The rubber elastomer used in, for example, the base layer or the resistance-adjusting layer of the conductive member is composed of a conductive rubber composition. The conductive rubber composition may contain an ion-conductive agent as a material that imparts electrical conductivity.

For example, Japanese Unexamined Patent Application Publication No. 2003-165902 describes that a rubber composition is used as a material of a conductive roller used in an electrophotographic copy machine or the like. An example of this rubber composition contains an epihalohydrin rubber and, as an ion-conductive agent, a quaternary ammonium salt, such as diallyldimethylammonium chloride.

Such a conductive member has a problem in that when a voltage is applied for a long time, a charging performance for a counterpart member such as a photoconductor drum or a toner decreases. It is believed that this is because the ion-conductive agent contained in the conductive member is consumed during the long-term voltage application, resulting in an increase in the resistance.

As a result, charging of the counterpart member is not satisfactorily performed, and an image defect may be caused. Accordingly, hitherto, such an adverse effect on an image has been prevented by, for example, adjusting the voltage to be applied in the main body of an electrophotographic device. Consequently, the cost of the electrophotographic device has been high.

### SUMMARY OF THE INVENTION

It is desirable to provide a conductive member for an electrophotographic device, in which a decrease in the charging performance for a counterpart member can be suppressed even when a voltage is applied for a long time.

A conductive member for an electrophotographic device according to an aspect of the present invention includes a conductive rubber elastic layer, wherein the conductive rubber elastic layer is composed of a cross-linked product of a conductive rubber composition containing (a) a polar rubber, (b) at least one ion-conductive agent selected from diallyldimethylammonium.bis(trifluoromethanesulfonyl)imide and diallyldimethylammonium.trifluoromethanesulfonate and (c) a cross-linking agent, and the cross-linked product has a relative dielectric constant of 23 or more.

In this case, the component (a) is preferably at least one polar rubber selected from a hydrin rubber, a nitrile rubber, a urethane rubber, an acrylic rubber, a chloroprene rubber, and an epoxidized natural rubber.

The content of the component (b) is preferably 0.1 to 10 parts by mass relative to 100 parts by mass of the component (a).

According to the conductive member for an electrophotographic device according to the aspect of the present invention, a conductive rubber elastic layer is composed of a cross-linked product of a conductive rubber composition containing a polar rubber, an ion-conductive agent composed of a specific diallyldimethylammonium salt and a cross-linking agent, wherein the cross-linked product has a relative dielectric constant of 23 or more. Therefore, even when a voltage is applied for a long time, a decrease in the charging performance for a counterpart member can be suppressed.

### BRIEF DESCRIPTION OF THE DRAWINGS

FIGS. 1A and 1B are cross-sectional views in the circumferential direction each illustrating a layer structure of a conductive roller which is a conductive member for an electrophotographic device according to an embodiment of the present invention; and

FIG. 2 is a partial cross-sectional view illustrating a layer structure of a conductive belt which is a conductive member for an electrophotographic device according to an embodiment of the present invention.

### DESCRIPTION OF THE PREFERRED EMBODIMENTS

Embodiments of a conductive member for an electrophotographic device according to the present invention will be described in detail.

The conductive member according to an embodiment of the present invention includes a conductive rubber elastic layer composed of a cross-linked product of a specific conductive rubber composition. Examples of the conductive member according to an embodiment of the present invention include conductive rollers such as a developing roller, a charging roller, a transfer roller and a toner supply roller used in an electrophotographic device; and conductive belts, such as a transfer belt, used in an electrophotographic device.

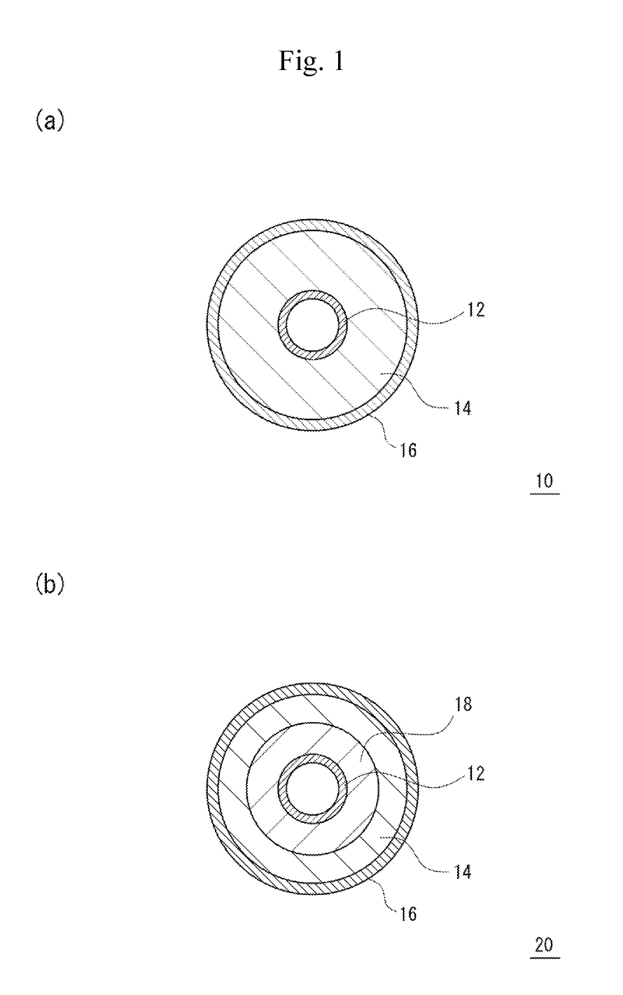

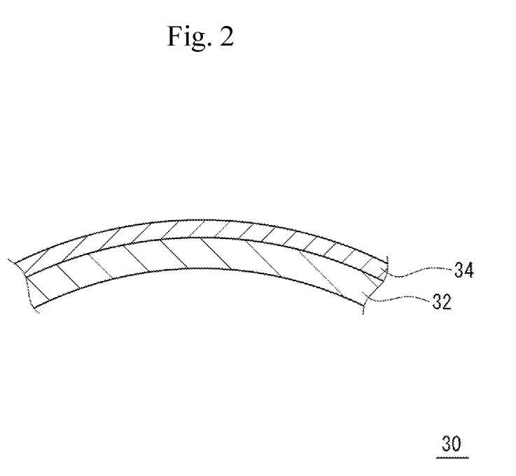

Examples of the structure of a conductive roller will be described. As illustrated in FIG. 1A, a conductive roller 10 has a two-layer structure in which a conductive rubber elastic layer 14 and a surface layer 16 are stacked in that order on the outer periphery of a shaft 12. As illustrated in FIG. 1B, a conductive roller 20 has a three-layer structure in which a conductive rubber elastic layer 18, a conductive rubber elastic layer 14, and a surface layer 16 are stacked in that order on the outer periphery of a shaft 12. The structure of the conductive roller is not limited to the structures illustrated in FIGS. 1A and 1B. Alternatively, for example, three or more conductive rubber elastic layers may be provided on the outer periphery of the shaft 12. Regarding an example of the structure of a conductive belt, as illustrated in FIG. 2, a conductive belt 30 has a two-layer structure in which a conductive rubber elastic layer 32 and a surface layer 34 are stacked in that order.

The inner conductive rubber elastic layer 18 of the conductive roller 20 illustrated in FIG. 1B, functions as a base layer of the conductive roller 20 and may be a foamed layer or a non-foamed layer. The outer conductive rubber elastic layer 14 of the conductive roller 20 is a layer having a function of, for example, adjusting the resistance of the conductive roller 20. In the case of the conductive roller 20, which includes two conductive rubber elastic layers, only the outer conductive rubber elastic layer 14 may be composed of the specific conductive rubber composition or both the inner conductive rubber elastic layer 18 and the outer conductive rubber elastic layer 14 may be composed of the specific conductive rubber composition.

The specific conductive rubber composition forming the conductive rubber elastic layer 14 contains at least (a) a polar rubber, (b) a specific ion-conductive agent and (c) a cross-linking agent.

The polar rubber (a) is a rubber having a polar group. Examples of the polar group include a chloro group, a nitrile group, a carboxyl group, and an epoxy group. Specific examples of the polar rubber (a) include a hydrin rubber, a nitrile rubber (NBR), a urethane rubber (U), an acrylic rubber (copolymer of an acrylic acid ester and 2-chloroethyl vinyl ether, ACM), a chloroprene rubber (CR) and an epoxidized natural rubber (ENR).

Among the specific polar rubbers (a), from the standpoint that, for example, the volume resistivity of the conductive rubber composition is particularly easily reduced, a hydrin rubber and a nitrile rubber (NBR) are preferable.

Examples of the hydrin rubber include a homopolymer of epichlorohydrin (CO), an epichlorohydrin-ethylene oxide binary copolymer (ECO), an epichlorohydrin-allylglycidyl ether binary copolymer (GCO) and an epichlorohydrin-ethylene oxide-allylglycidyl ether ternary copolymer (GECO).

Examples of the urethane rubber include polyether urethane rubbers having an ether bond in the molecule thereof. Such polyether urethane rubbers can be produced by a reaction between a polyether having hydroxyl groups at both ends thereof and a diisocyanate. Examples of the polyether include, but are not particularly limited to, polyethylene glycol and polypropylene glycol. Examples of the diisocyanate include, but are not particularly limited to, tolylene diisocyanate and diphenylmethane diisocyanate.

The specific ion-conductive agent (b) is selected from diallyldimethylammonium.bis(trifluoromethanesulfonyl)imide (DAM.TFSI) and diallyldimethylammonium.trifluoromethanesulfonate (DAM.TF). These may be used alone or in combination. The structural formula of DAM.TFSI is represented by formula (1), and the structural formula of DAM.TF is represented by formula (2).

[(CH₂═CHCH₂)₂(CH₃)₂N]⁺.(CF₃SO₂)₂N⁻ (1)

[(CH₂═CHCH₂)₂(CH₃)₂N]⁺.(CF₃SO₃)⁻ (2)

It is believed that diallyldimethylammonium (DAM) of DAM.TFSI and DAM.TF is dispersed in the polar rubber (component (a)) during rubber kneading, and diallyldimethylammonium itself then polymerizes during cross-linking (during heating) in the presence of a radical (in the presence of a cross-linking agent) as represented by formula (3) and the diallyldimethylammonium having a high molecular weight bonds to the polar rubber. Thus, the specific ion-conductive agent is introduced in the polymer backbone of the polar rubber in the form of the structure represented by formula (3).

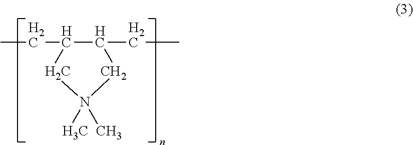

Here, it is believed that with an increase in the molecular weight of diallyldimethylammonium, the relative dielectric constant of the resulting cross-linked product of the conductive rubber composition increases. Thus, the charging performance of the cross-linked product is increased. It is believed that this is because the increase in the molecular weight of diallyldimethylammonium increases the charge density on the nitrogen (N) atom.

Furthermore, in the case where diallyldimethylammonium polymerizes and the diallyldimethylammonium having a high molecular weight bonds to the polar rubber as described above, the migration of the ion-conductive agent in the conductive rubber elastic layer is suppressed during the application of a voltage to the conductive member. It is believed that, consequently, the ion-conductive agent is not easily consumed during the application of the voltage to the conductive member, and thus a decrease in the charging performance due to the voltage application can be suppressed.

Furthermore, in the specific ion-conductive agent (b), TFSI and TF, which are anions, contain a plurality of fluorine groups in the structure thereof. Therefore, the basicity of each of these anions themselves is low, and the anion forms a relatively weak ionic bond with a cation. Accordingly, ammonium salts of these anions easily dissociate into ions in the polar rubber, and the relative dielectric constant can be particularly made large. Thus, the charging performance of the cross-linked product can be improved. In addition, it is believed that, in the specific ion-conductive agent (b), diallyldimethylammonium itself polymerizes because the anion is TFSI or TF. It is believed that, if the anion in a chlorine (Cl) anion, diallyldimethylammonium does not easily polymerize because the Cl anion has a high basicity, and thus the Cl anion does not easily dissociate into an ion in the polar rubber and, in the form of a salt, the degree of freedom of the molecule itself decreases.

The content of the specific ion-conductive agent (b) is preferably in the range of 0.1 to 10 parts by mass, more preferably 0.3 to 5 parts by mass and still more preferably 0.5 to 3 parts by mass relative to 100 parts by mass of the polar rubber (a). When the content of the specific ion-conductive agent (b) is less than 0.1 parts by mass, the effect of increasing the charging performance of a cross-linked product tends to decrease. On the other hand, when the content exceeds 10 parts by mass, the specific ion-conductive agent (b) easily bleeds from a cross-linked product, which may cause a contamination on a counterpart member that contacts the conductive member.

The cross-linking agent (c) is not particularly limited as long as the cross-linking agent cross-links the polar rubber (a). Examples of the cross-linking agent (c) include sulfur cross-linking agents, peroxide cross-linking agents, and dechlorination cross-linking agents. These cross-linking agents may be used alone or in combination of two or more cross-linking agents.

Examples of the sulfur cross-linking agent include known sulfur cross-linking agents such as sulfur powders, precipitated sulfur, colloidal sulfur, surface-treated sulfur, insoluble sulfur, sulfur chloride, thiuram vulcanization accelerators and polysulfides.

Examples of the peroxide cross-linking agent include known peroxide cross-linking agents such as peroxyketals, dialkyl peroxides, peroxyesters, ketone peroxides, peroxydicarbonates, diacyl peroxides and hydroperoxides.

Examples of the dechlorination cross-linking agent include dithiocarbonate compounds. Specific examples thereof include quinoxaline-2,3-dithiocarbonate, 6-methylquinoxaline-2,3-dithiocarbonate, 6-isopropylquinoxaline-2,3-dithiocarbonate and 5,8-dimethylquinoxaline-2,3-dithiocarbonate.

The content of the cross-linking agent (c) is preferably in the range of 0.1 to 3 parts by mass, more preferably 0.3 to 2.5 parts by mass, and still more preferably 0.5 to 2.5 parts by mass relative to 100 parts by mass of the polar rubber (a) from the standpoint that, for example, bleeding of the cross-linking agent (c) does not easily occur.

In the case where the dechlorination cross-linking agent is used as the cross-linking agent (c), a dechlorination cross-linking accelerator may be used in combination. Examples of the dechlorination cross-linking accelerator include 1,8-diazabicyclo[5.4.0]undecene-7 (hereinafter abbreviated as “DBU”) and weak acid salts thereof. The dechlorination cross-linking accelerator may be used in the form of DBU. However, in view of handleability of the dechlorination cross-linking accelerator, the dechlorination cross-linking accelerator is preferably used in the form of a weak acid salt of DBU. Examples of the weak acid salt of DBU include carbonates, stearates, 2-ethylhexylates, benzoates, salicylates, 3-hydroxy-2-naphthoates, phenol resin salts, 2-mercaptobenzothiazole salts and 2-mercaptobenzimidazole salts of DBU.

The content of the dechlorination cross-linking accelerator is preferably in the range of 0.1 to 2 parts by mass, more preferably 0.3 to 1.8 parts by mass and still more preferably 0.5 to 1.5 parts by mass relative to 100 parts by mass of the polar rubber (a) from the standpoint that, for example, bleeding does not easily occur.

The specific conductive rubber composition may contain at least one additive selected from an electron conductive agent such as carbon black, a lubricant, an age resistor, a light stabilizer, a viscosity-adjusting agent, a processing aid, a flame retardant, a plasticizer, a foaming agent, a filler, a dispersant, an antifoaming agent, a pigment and a mold release agent, as required.

In the conductive member according to an embodiment of the present invention, the cross-linked product composed of the above-described specific conductive rubber composition has a relative dielectric constant of 23 or more. The relative dielectric constant of the cross-linked product is more preferably 40 or more, and still more preferably 50 or more. When the relative dielectric constant of the cross-linked product is less than 23, the charging performance of the conductive member is not satisfied. The relative dielectric constant of the cross-linked product can be adjusted by changing, for example, the type of polar rubber (a), the type of specific ion-conductive agent (b) or the content of the specific ion-conductive agent (b).

The thicknesses of the conductive rubber elastic layers 14 and 32 composed of a cross-linked product of the specific conductive rubber composition are not particularly limited. However, in the case of the conductive rollers 10 and 20, the thickness of the conductive rubber elastic layer 14 is preferably in the range of 0.1 to 10 mm, more preferably 0.5 to 5 mm and still more preferably 1 to 3 mm. In the case of the conductive belt 30, the thickness of the conductive rubber elastic layer 32 is preferably in the range of 30 to 300 μm and more preferably 50 to 200 μm.

The volume resistivity of the conductive rubber elastic layer 14 formed of a cross-linked product of the specific conductive rubber composition is not particularly limited, but is preferably in the range of 10² to 10¹⁰ Ω·cm, more preferably 10³ to 10⁹ Ω·cm and still more preferably 10⁴ to 10⁸ Ω·cm.

The shaft 12 of each of the conductive rollers 10 and 20 is not particularly limited as long as the shaft 12 has electrical conductivity. Specifically, examples of the shaft 12 include metal cores composed of a solid body or a hollow body made of a metal such as iron, stainless steel or aluminum. An adhesive, a primer and the like may be applied onto the surface of the shaft 12, as required. Electrical conductivity may be imparted to the adhesive, the primer and the like, as required.

The surface layer 16 of each of the conductive rollers 10 and 20 can function as, for example, a protective layer of the surface of the roller. Examples of a main material forming the surface layer 16 include, but are not particularly limited to, acrylic resins, urethane resins, alkyd resins, amide resins, phenol resins, fluorocarbon resins and silicone resins. These resins may be modified resins. Examples of a modifying group include an N-methoxymethyl group, a silicone group and a fluorine group.

In order to impart electrical conductivity, known conductive agents such as carbon black, graphite, c-TiO₂, c-ZnO, c-SnO₂ (where c- represents “conductive”) and ion-conductive agents (e.g., a quaternary ammonium salt, a borate, and a surfactant) may be added to the surface layer 16, as required. Furthermore, various additives may also be added to the surface layer 16, as required.

The thickness of the surface layer 16 is not particularly limited, but is preferably in the range of 0.01 to 100 μm more preferably 0.1 to 20 μm and still more preferably 0.3 to 10 μm. The volume resistivity of the surface layer 16 is preferably in the range of 10⁷ to 10¹² Ω·cm, more preferably 10⁸ to 10¹¹ Ω·cm and still more preferably 10⁹ to 10¹⁰ Ω·cm.

In the case where the inner conductive rubber elastic layer 18 of the conductive roller 20 is not composed of the specific conductive rubber composition, examples of a main material forming the conductive rubber elastic layer 18 include an ethylene-propylene rubber (EPDM), a styrene-butadiene rubber (SBR), a natural rubber (NR), a polynorbornene rubber, a silicone rubber, a nitrile rubber (NBR and H-NBR) and a chloroprene rubber (CR). These rubbers may be used alone or in combination of two or more rubbers.

In order to impart electrical conductivity, known conductive agents such as carbon black, graphite, c-TiO₂, c-ZnO, c-SnO₂ (where c- represents “conductive”) and ion-conductive agents (e.g., a quaternary ammonium salt, a borate, and a surfactant) may be added to the inner conductive rubber elastic layer 18, as required. By incorporating these conductive agents, it is possible to obtain electrical conductivity represented by a volume resistivity in the range of 5×10² to 1×10⁵ Ω·cm.

Various additives may also be added to the conductive rubber elastic layer 18, as required. Examples of the additives include an extending agent, a reinforcing agent, a processing aid, a curing agent, a cross-linking agent, a cross-linking accelerator, a foaming agent, an antioxidant, a plasticizer, an ultraviolet absorber, a silicone oil, a lubricant, an auxiliary agent and a surfactant.

The thickness of the inner conductive rubber elastic layer 18 is not particularly limited, but is preferably in the range of 0.1 to 10 mm, more preferably 0.5 to 5 mm and still more preferably 1 to 3 mm. The volume resistivity of the inner conductive rubber elastic layer 18 is not particularly limited, but is preferably in the range of 10² to 10¹⁰ Ω·cm, more preferably 10³ to 10⁹ Ω·cm and still more preferably 10⁴ to 10⁸ Ω·cm.

The surface layer 34 of the conductive belt 30 may have the same structure as the surface layer 16 of the conductive rollers 10 and 20.

The conductive roller 10 can be produced, for example, as follows: first, a conductive rubber elastic layer 14 is formed on the outer periphery of a shaft 12. For example, the conductive rubber elastic layer 14 is formed by concentrically arranging the shaft 12 in a hollow portion of a roll-forming die, injecting the specific conductive rubber composition into the die, curing the conductive rubber composition by heating and then detaching the shaft 12 from the die. Alternatively, the conductive rubber elastic layer 14 is formed on the surface of the shaft 12 by extrusion molding using the specific conductive rubber composition. Next, a surface layer 16 is formed by applying a composition for forming a surface layer onto the outer periphery of the conductive rubber elastic layer 14, and conducting ultraviolet irradiation or heat treatment, as required. Thus, the conductive roller 10 can be produced.

The composition for forming a surface layer contains the above-described main material, a conductive agent and optional other additives. The composition may contain a solvent such as an organic solvent, e.g., methyl ethyl ketone, toluene, acetone, ethyl acetate, butyl acetate, methyl isobutyl ketone (MIBK), tetrahydrofuran (THF) or dimethylformamide (DMF) or a water-soluble solvent, e.g., methanol or ethanol, as required, from the standpoint of adjusting the viscosity, for example. Various coating methods such as a roll-coating method, a dipping method, and a spray coating method can be employed for the application of the composition.

The conductive roller 20 can be produced, for example, as follows: first, an inner conductive rubber elastic layer 18 is formed on the outer periphery of a shaft 12. For example, the inner conductive rubber elastic layer 18 is formed by concentrically arranging the shaft 12 in a hollow portion of a roll-forming die, injecting a material forming the inner conductive rubber elastic layer 18 into the die, curing the material by heating and then detaching the shaft 12 from the die. Alternatively, the inner conductive rubber elastic layer 18 is formed on the surface of the shaft 12 by extrusion molding using the material forming the inner conductive rubber elastic layer 18. Next, an outer conductive rubber elastic layer 14 is formed. For example, the outer conductive rubber elastic layer 14 is formed by concentrically arranging the shaft 12, on which the inner conductive rubber elastic layer 18 is formed, in a hollow portion of a roll-forming die, injecting the specific conductive rubber composition into the die, curing the conductive rubber composition by heating and then detaching the shaft 12 from the die. Alternatively, the outer conductive rubber elastic layer 14 is formed on the surface of the inner conductive rubber elastic layer 18 by extrusion molding using the specific conductive rubber composition. Next, a surface layer 16 is formed by applying a composition for forming a surface layer onto the outer periphery of the outer conductive rubber elastic layer 14 and conducting ultraviolet irradiation or heat treatment, as required. Thus, the conductive roller 20 can be produced.

The conductive belt 30 can be produced, for example, as follows: first, a conductive rubber elastic layer 32 is formed by applying the specific conductive rubber composition onto a surface of a cylindrical die by spray coating and curing the conductive rubber composition by heating. Next, a surface layer 34 is formed by applying a composition for forming a surface layer onto the outer periphery of the conductive rubber elastic layer 32 by spray coating and curing the composition by heating. Next, the cylindrical die is removed by pulling it while blowing air between the conductive rubber elastic layer 32 and the cylindrical die. Thus, the conductive belt 30 can be produced. The specific conductive rubber composition may contain a solvent, as required, when being applied by spray coating.

According to the above-described conductive member according to an embodiment of the present invention, a conductive rubber elastic layer is composed of a cross-linked product of a conductive rubber composition containing a polar rubber, an ion-conductive agent composed of a specific diallyldimethylammonium salt and a cross-linking agent, wherein the cross-linked product has a relative dielectric constant of 23 or more. Therefore, even when a voltage is applied for a long time, a decrease in the charging performance for a counterpart member can be suppressed.

### EXAMPLES

The present invention will now be described in detail by way of Examples. In the Examples, a description will be made of a conductive roller having a two-layer structure in which a conductive rubber elastic layer and a surface layer are stacked in that order on the outer periphery of a shaft. However, the present invention is not limited to this structure.

### Example 1

### Preparation of DAM.TFSI

Diallyldimethylammonium chloride and lithium bis(trifluoromethanesulfonyl)imide were added to an aqueous solvent and the resulting mixture was stirred at room temperature for four hours to prepare diallyldimethylammonium.bis(trifluoromethanesulfonyl)imide (DAM.TFSI).

### [Preparation of Conductive Rubber Composition]

To 100 parts by mass of a hydrin rubber (ECO, manufactured by Zeon Corporation “Hydrin T3106”), 0.1 parts by mass of DAM.TFSI, serving as an ion-conductive agent, and 2 parts by mass of sulfur (manufactured by Tsurumi Chemical Industry Co., Ltd., “Sulfur-PTC”), serving as a cross-linking agent, were added. These components were stirred and mixed with a mixer to prepare a conductive rubber composition of Example 1.

### [Production of Conductive Roller]

### (Formation of Conductive Rubber Elastic Layer)

A metal core having a diameter of 6 mm was placed in a forming die. The conductive rubber composition was injected into the die, heated at 170° C. for 30 minutes and then cooled. The metal core was detached from the die. Thus, a conductive rubber elastic layer having a thickness of 1.5 mm was formed on the outer periphery of the metal core.

### (Formation of Surface Layer)

One hundred parts by mass of N-methoxymethylated nylon (manufactured by Nagase ChemteX Corporation, “EF30T”), 60 parts by mass of conductive tin oxide (manufactured by Mitsubishi Materials Corporation “S-2000”), 1 part by mass of citric acid and 300 parts by mass of methanol were mixed to prepare a composition for forming a surface layer. Next, the composition for forming a surface layer was applied onto the surface of the conductive rubber elastic layer by roll coating and then heated at 120° C. for 50 minutes to form a surface layer having a thickness of 10 μm on the outer periphery of the conductive rubber elastic layer. Thus, a conductive roller of Example 1 was produced.

### Examples 2 and 3

Conductive rubber compositions of Examples 2 and 3 were prepared and then conductive rollers of Examples 2 and 3 were produced as in Example 1 except that the amount of DAM.TFSI mixed was changed to those shown in Table 1 in the preparation of the conductive rubber compositions.

### Example 4

### Preparation of DAM.TF

Diallyldimethylammonium chloride and lithium trifluoromethanesulfonate were added to an aqueous solvent and the resulting mixture was stirred at room temperature for four hours to prepare diallyldimethylammonium.trifluoromethanesulfonate (DAM.TF).

### [Production of Conductive Roller]

A conductive rubber composition of Example 4 was prepared and then a conductive roller of Example 4 was produced as in Example 1 except that DAM.TF was used instead of DAM.TFSI in the preparation of the conductive rubber composition.

### Examples 5 and 6

Conductive rubber compositions of Examples 5 and 6 were prepared and then conductive rollers of Examples 5 and 6 were produced as in Example 4 except that the amount of DAM.TF mixed was changed to those shown in Table 1 in the preparation of the conductive rubber compositions.

### Examples 7 and 8

Conductive rubber compositions of Examples 7 and 8 were prepared and then conductive rollers of Examples 7 and 8 were produced as in Example 2 except that the polar rubbers shown in Table 1 were used instead of the hydrin rubber in the preparation of the conductive rubber compositions.

### (Preparation of Various Ion-Conductive Agents)

### [Preparation of DAM.Br]

Diallyldimethylammonium.bromide (DAM.Br) was prepared by allowing N-methylmethanamine to react with allyl bromide.

### [Preparation of TBA.TFSI]

Tetrabutylammonium chloride and lithium bis(trifluoromethanesulfonyl)imide were added to an aqueous solvent and the resulting mixture was stirred at room temperature for four hours to prepare tetrabutylammonium.bis(trifluoromethanesulfonyl)imide (TBA.TFSI).

### [Preparation of TBA.TF]

Tetrabutylammonium chloride and lithium trifluoromethanesulfonate were added to an aqueous solvent and the resulting mixture was stirred at room temperature for four hours to prepare tetrabutylammonium.trifluoromethanesulfonate (TBA.TF).

### [Preparation of TEA.TFSI]

Tetraethylammonium chloride and lithium bis(trifluoromethanesulfonyl)imide were added to an aqueous solvent and the resulting mixture was stirred at room temperature for four hours to prepare tetraethylammonium.bis(trifluoromethanesulfonyl)imide (TEA.TFSI).

### [Preparation of TEA.TF]

Tetraethylammonium chloride and lithium trifluoromethanesulfonate were added to an aqueous solvent, and the resulting mixture was stirred at room temperature for four hours to prepare tetraethylammonium.trifluoromethanesulfonate (TEA.TF).

### Comparative Examples 1 to 7

Conductive rubber compositions of Comparative Examples 1 to 7 were prepared and then conductive rollers of Comparative Examples 1 to 7 were produced as in Example 1 except that the ion-conductive agents shown in Table 2 were used instead of DAM.TFSI, and the amount of ion-conductive agent mixed was changed to those shown in Table 2 in the preparation of the conductive rubber compositions.

### (Materials)

NBR: Nipol DN212, manufactured by Zeon Corporation
U: Millathane CM, manufactured by TSE Industries, Inc.
DAM.Cl: Diallyldimethylammonium chloride, manufactured by Tokyo Chemical Industry Co., Ltd.

A relative dielectric constant of a sheet material was measured using each of the conductive rubber compositions prepared above. A charging performance, a bleeding property and an image were evaluated using each of the conductive rollers produced above. Measurement methods and evaluation methods will be described below.

### (Relative Dielectric Constant of Sheet Material)

Press forming with cross-linking was performed at 170° C. for 30 minutes using each conductive rubber composition to obtain a sheet material having a thickness of 2 mm. An electrode having a size of 10×10 mm (with a guard electrode) was formed by applying a silver paste onto a surface of the sheet material. A counter electrode was formed on a surface opposite to the surface having the electrode thereon. An electrostatic capacity C [F] was measured with an LCZ meter (manufactured by Yokogawa-Hewlett-Packard, Ltd. (YHP), 4276A) in an environment of 25° C. and 50% RH without application of a DC voltage, under an AC applied voltage of 1 V, and at a frequency of 1 kHz. A relative dielectric constant ∈ of the sheet material was calculated by formula (4) below:

∈=C×d/∈₀×S (4)

In formula (4), d represents the distance between the electrodes, i.e., the thickness (m) of the sheet material, ∈₀ represents the dielectric constant in the vacuum (=8.855×10⁻¹² [F/m]) and S represents the electrode area [m²].

### (Charging Performance)

Each conductive roller was installed as a charging roller in a cartridge of a multifunctional peripheral (MFP) device manufactured by Canon Inc. (iR4570). A voltage of −600 V of 1.1 kVpp at 1,800 Hz was applied to the charging roller in an environment of 23° C. and 53% RH while rotating a photoconductor drum and the charging roller at a speed of 60 rpm in a state where the photoconductor drum and the charging roller are brought into contact with each other. At this time, a probe of a surface potential meter (manufactured by Trek Japan Co., Ltd., Model-370) was arranged at a position rotated by 90° from the position of the charging roller in the circumferential direction of the photoconductor drum and separated by 2 mm from the photoconductor drum and the surface potential (the amount of charge) at a central portion of the photoconductor drum was measured in the dark. When the average of the waveform in the second round was −580 V or less, the sample was evaluated as “excellent (A)”. When the average of the waveform in the second round was more than −580 V and less than −570 V, the sample was evaluated as “slightly poor (B)”. When the average of the waveform in the second round was −570 V or more, the sample was evaluated as “no good (C)”.

### (Bleeding)

The conductive roller was left to stand in an environment of 40° C. and 90% RH for one month, and the surface state of the roller was then observed. When no change was observed on the surface, the sample was evaluated as “excellent (A)”. When wrinkles and floating were slightly observed on the surface, the sample was evaluated as “good (B)”. When wrinkles and floating were significantly observed on the surface, the sample was evaluated as “no good (C)”.

### (Image Evaluation)

The conductive roller was installed as a charging roller in a cartridge of a multifunctional peripheral (MFP) device manufactured by Canon Inc. (iR4570). A single half-tone image was printed in an environment of 15° C. and 10% RH at the initial stage and after 60,000 copies were printed (after 60 K). When uneven density was not observed and no streak image was formed in the half-tone image, the sample was evaluated as “excellent (A)”. When uneven density was slightly observed and a streak image was slightly formed in the half-tone image, the sample was evaluated as “good (B)”. When uneven density was significantly observed and a streak image was significantly formed in the half-tone image, the sample was evaluated as “no good (C)”.

TABLE 1

| | Example | | | | | | | |
|---|---|---|---|---|---|---|---|---|
| | 1 | 2 | 3 | 4 | 5 | 6 | 7 | 8 |
| Polar rubber | ECO | | | | | | NBR | U |
| Ion-conductive | | | | | | | | |
| agent | | | | | | | | |
| Cationic | DAM | | | | | | | |
| species | | | | | | | | |
| Anionic species | TFSI | | | TF | | | TFSI | |
| Amount added | 0.1 | 3 | 10 | 0.1 | 3 | 10 | 3 | 3 |
| (phr) | | | | | | | | |
| Characteristic | | | | | | | | |
| evaluation | | | | | | | | |
| Relative | 25 | 55 | 120 | 23 | 40 | 105 | 40 | 35 |
| dielectric | | | | | | | | |
| constant of | | | | | | | | |
| sheet material | | | | | | | | |
| Charging | A | A | A | A | A | A | A | A |
| performance | | | | | | | | |
| Bleeding | A | A | B | A | A | B | A | A |
| Initial image | A | A | A | A | A | A | A | A |
| Image after | A | A | A | A | A | A | A | A |
| durability test | | | | | | | | |

TABLE 2

| | Comparative Example | | | | | | |
|---|---|---|---|---|---|---|---|
| | 1 | 2 | 3 | 4 | 5 | 6 | 7 |
| Polar rubber | ECO | | | | | | |
| Ion-conductive | | | | | | | |
| agent | | | | | | | |
| Cationic | DAM | TBA | | TEA | | DAM | |
| species | | | | | | | |
| Anionic species | Br | TFSI | TF | TFSI | TF | Cl | |
| Amount added | 3 | 3 | 3 | 3 | 3 | 1.5 | 3 |
| (phr) | | | | | | | |
| Characteristic | | | | | | | |
| evaluation | | | | | | | |
| Relative | 18 | 20 | 18 | 21 | 18 | 17 | 18 |
| dielectric | | | | | | | |
| constant of | | | | | | | |
| sheet material | | | | | | | |
| Charging | C | B | C | B | C | C | C |
| performance | | | | | | | |
| Bleeding | A | A | A | A | A | A | A |
| Initial image | A | B | B | B | B | B | A |
| Image after | C | C | C | C | C | C | C |
| durability test | | | | | | | |

In the Comparative Examples, the cationic species or the anionic species of the ion-conductive agent is not a species specified in the present invention. As in Comparative Examples 1, 6 and 7, in the case where DAM.Cl or DAM.Br is used as the ion-conductive agent, since the basicity of the anion itself is excessively high, the ion-conductive agent does not easily dissociate into ions in the polar rubber. In addition, DAM does not polymerize during cross-linking of the rubber. Furthermore, the ion-conductive agent is not satisfactorily dispersed during rubber kneading. Consequently, in Comparative Examples 1, 6 and 7, the relative dielectric constant of the sheet material was low and also the charging performance of the conductive roller was poor. Furthermore, the ion-conductive agent was consumed during the durability test and a defect was generated in the image after the durability test. In Comparative Examples 2 to 5, since the cationic species was not introduced in the backbone of the polar rubber, the ion-conductive agent was consumed during the durability test and a defect was generated in the image after the durability test. In addition, in Comparative Examples 2 to 5, the relative dielectric constant of the sheet material was low and also the charging performance of the conductive roller was poor.

In contrast, in Examples 1 to 8, it was confirmed that the relative dielectric constant of the sheet material was high and the conductive roller was excellent in terms of charging performance. Furthermore, it was confirmed that the generation of a defect of an image after the durability test could be suppressed.

Embodiments of the present invention have been described in detail. However, the present invention is not limited to the Examples described above and various modifications can be made without departing from the gist of the present invention.

1. A conductive member for an electrophotographic device, comprising:
a conductive rubber elastic layer,
wherein the conductive rubber elastic layer is composed of a cross-linked product of a conductive rubber composition containing
(a) a polar rubber,
(b) at least one ion-conductive agent selected from diallyldimethylammonium.bis(trifluoromethanesulfonyl)imide and diallyldimethylammonium.trifluoromethanesulfonate, and
(c) a cross-linking agent, and
the cross-linked product has a relative dielectric constant of 23 or more.

2. The conductive member according to claim 1, wherein the component (a) is at least one polar rubber selected from a hydrin rubber, a nitrile rubber, a urethane rubber, an acrylic rubber, a chloroprene rubber and an epoxidized natural rubber.

3. The conductive member according to claim 1, wherein the content of the component (b) is 0.1 to 10 parts by mass relative to 100 parts by mass of the component (a).

4. A conductive roller comprising the conductive rubber elastic layer according to claim 1 and a surface layer, stacked in this order, on an outer periphery of a shaft.

5. A conductive roller comprising an outer conductive rubber elastic layer, and inner conductive elastic layer and a surface layer, stacked in this order, on an outer periphery of a shaft;
wherein the outer conductive rubber elastic layer is the conductive rubber elastic layer according to claim 1.

6. A conductive roller comprising an outer conductive rubber elastic layer, and inner conductive elastic layer and a surface layer, stacked in this order, on an outer periphery of a shaft;
wherein the inner conductive rubber elastic layer is the conductive rubber elastic layer according to claim 1.

7. A conductive belt comprising the conductive rubber elastic layer according to claim 1 and a surface layer, stacked in this order.

8. The conductive member according to claim 1, wherein the component (b) is diallyldimethylammonium.trifluoromethanesulfonate.

9. The conductive member according to claim 1, wherein the component (b) is diallyldimethylammonium.bis(trifluoromethanesulfonyl)imide.

10. The conductive member according to claim 1, wherein the component (b) is diallyldimethylammonium.bis(trifluoromethanesulfonyl)imide and diallyldimethylammonium.trifluoromethanesulfonate.

11. The conductive member according to claim 1, wherein the component (c) is selected from the group consisting of sulfur cross-linking agents, peroxide cross-linking agents, and dechlorination cross-linking agents.

12. The conductive member according to claim 1, wherein the content of the component (c) is 0.1 to 3 parts by mass relative to 100 parts by mass of the component (a).

13. The conductive member according to claim 1, wherein the component (c) is a dechlorination cross-linking agents, and the component (c) further comprises a dechlorination cross-linking accelerator.

14. The conductive member according to claim 1, wherein the cross-linked product has a relative dielectric constant of 50 or more.

15. The conductive member according to claim 1, wherein the conductive rubber elastic layer has a volume resistivity of 10² to 10¹⁰ Ω·cm.

16. The conductive roller according to claim 4, wherein the surface layer comprises a resin selected from the group consisting of acrylic resins, urethane resins, alkyd resins, amide resins, phenol resins, fluorocarbon resins and silicone resins.

17. The conductive roller according to claim 5, wherein the surface layer comprises a resin selected from the group consisting of acrylic resins, urethane resins, alkyd resins, amide resins, phenol resins, fluorocarbon resins and silicone resins.

18. The conductive belt according to claim 7, wherein the surface layer comprises a resin selected from the group consisting of acrylic resins, urethane resins, alkyd resins, amide resins, phenol resins, fluorocarbon resins and silicone resins.
